(19) United States
(12) Patent Application Publication
(10) Pub. No.: US 2025/0108838 A1
(43) Pub. Date: Apr. 3, 2025

(54) SYSTEMS AND METHODS FOR DISENGAGING AND TRANSFERRING CONTROL OF A GROUPED VEHICLE

(71) Applicant: Toyota Motor Engineering & Manufacturing North America, Inc., Plano, TX (US)

(72) Inventor: Christopher A. Ferone, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/476,703

(22) Filed: Sep. 28, 2023

(51) Int. Cl. B60W 60/00; B60W 30/165; B60W 40/04; G08G 1/00

(52) U.S. Cl. CPC B60W 60/0027; B60W 30/165; B60W 40/04; G08G 1/22; B60W 2554/4041; B60W 2554/4042; B60W 2556/10; B60W 2556/65

(57) ABSTRACT

Systems, methods, and other embodiments described herein relate to disengaging a grouped vehicle by transferring control to an operator safely from a communication interruption. In one embodiment, a method includes predicting a communication interruption between a leading vehicle and a following vehicle that are traveling on a road as a group. The method also includes, upon communication parameters being unsatisfied, controlling the following vehicle automatically using an actual path history for the leading vehicle until exhaustion. The method also includes maneuvering the following vehicle with an estimated trajectory using a predicted path history for the leading vehicle generated from a model following the exhaustion until a handover.

### TECHNICAL FIELD

The subject matter described herein relates, in general, to disengaging grouped vehicles, and, more particularly, to disengaging a grouped vehicle by transferring control to an operator safely from a communication interruption.

### BACKGROUND

Systems for traffic control and management encounter difficulties maintaining traffic flow due to environmental changes and variability. For example, a traffic light that controls traffic flow onto an expressway can overestimate or underestimate available space between vehicles for traffic. As such, the system erroneously exacerbates stop-and-go traffic from miscalculations. Furthermore, a road having manual and automated vehicles can have varying traffic flows from differences in driving styles that decrease safety and efficiency. Accordingly, vehicles encounter unnecessary congestion and disruptions to traffic flow on roads from systems that control traffic that frustrate operators.

In various implementations, systems control traffic flow by coordinating motion with cooperative control (e.g., platooning) through linking vehicles virtually using wireless communications. The linked vehicles create virtual towing that follows a group formation. Cooperative control can reduce traffic congestion through optimized vehicle spacing and increase energy efficiency by reducing stop-and-go driving. However, grouped vehicles using cooperative control may encounter unsafe conditions from a communication interruption that can necessitate a vehicle leaving the group. For example, a communication interruption triggers a handover request for driving without warning an operator of the vehicle. This creates an unsafe condition within a traffic flow as grouped vehicles use inter-vehicle spacing (e.g., forward-spacing, rear-spacing, etc.) that is atypical for an operator to navigate. Therefore, systems using cooperative control can create unsafe conditions on a road when a hand-over to an operator is triggered from a communication interruption.

### SUMMARY

In one embodiment, example systems and methods relate to disengaging a grouped vehicle by transferring control to an operator safely from a communication interruption. In various implementations, traffic systems group vehicles through cooperative control (e.g., platooning) where the vehicles follow a linked formation (e.g., linear, offset, etc.) for improving traffic flow. In cooperative control, a following vehicle controls motion (e.g., cooperative adaptive cruise control (CACC)) on a road using information from a vehicle(s) traveling ahead transmitted through a wireless protocol (e.g., a vehicle-to-everything (V2X) communication). The control by the following vehicle sustains the formation using an automated driving system and information received with the wireless protocol. However, these systems encounter challenges when a communication interruption suddenly triggers a potential handover to an operator without warning. In certain driving scenarios, a human operator demands seconds to regain an understanding of surrounding conditions before resuming vehicle control safely. Accordingly, a system handing over control of a grouped vehicle to an operator too soon for a given traffic scenario can create a dangerous condition for a traffic flow.

Therefore, in one embodiment, a prediction system facilitates potential handovers and maintains automated driving for a vehicle in a group (e.g., a platoon) during a communication interruption (e.g., an outage) that triggers a potential disengagement and a handover such that an operator has reorientation time. In one approach, the prediction system facilitates the potential handover by automatically increasing a following-gap between a following vehicle and a leading vehicle due to the communication interruption. In this way, the vehicle is automatically repositioned to the following-gap that is a separation distance for disengaging (i.e., leaving) from the group using sensor data where the operator can safely maneuver the vehicle and understand the driving scenario. Regarding maintaining automated driving, the prediction system may automatically control the following vehicle using an actual path history recorded about the leading vehicle after the communication interruption is unable to satisfy communication parameters. Once the actual path history is exhausted and a potential handover is still pending, the following vehicle can maneuver with an estimated trajectory using a predicted path history for the leading vehicle. Accordingly, the prediction system mitigates an unsafe handover to an operator associated with a communication interruption for a grouped vehicle through automatic controls, thereby affording the operator sufficient readjustment and reorientation opportunities.

In one embodiment, a prediction system to disengage a grouped vehicle by transferring control to an operator safely from a communication interruption is disclosed. The prediction system includes a memory storing instructions that, when executed by a processor, cause the processor to predict a communication interruption between a leading vehicle and a following vehicle that are traveling on a road as a group. The instructions also include instructions to control, upon communication parameters being unsatisfied, the following vehicle automatically using an actual path history for the leading vehicle until exhaustion. The instructions also include instructions to maneuver the following vehicle with an estimated trajectory using a predicted path history for the leading vehicle generated from a model following the exhaustion until a handover.

In one embodiment, a non-transitory computer-readable medium to disengage a grouped vehicle by transferring control to an operator safely from a communication interruption and including instructions that when executed by a processor cause the processor to perform one or more functions is disclosed. The instructions include instructions to predict a communication interruption between a leading vehicle and a following vehicle that are traveling on a road as a group. The instructions also include instructions to control, upon communication parameters being unsatisfied, the following vehicle automatically using an actual path history for the leading vehicle until exhaustion. The instructions also include instructions to maneuver the following vehicle with an estimated trajectory using a predicted path history for the leading vehicle generated from a model following the exhaustion until a handover.

In one embodiment, a method for disengaging a grouped vehicle by transferring control to an operator safely from a communication interruption is disclosed. In one embodiment, the method includes predicting a communication interruption between a leading vehicle and a following vehicle that are traveling on a road as a group. The method also includes, upon communication parameters being unsatisfied, controlling the following vehicle automatically using an actual path history for the leading vehicle until exhaustion. The method also includes maneuvering the following vehicle with an estimated trajectory using a predicted path history for the leading vehicle generated from a model following the exhaustion until a handover.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that disengages a grouped vehicle by transferring control to an operator safely in association with a communication interruption.

FIG. 3 illustrates one example of the prediction system controlling a following vehicle traveling in a group with a leading vehicle where a communication interruption causes a potential handover.

FIG. 4 illustrates one embodiment of a method that is associated with predicting a communication interruption and controlling the following vehicle automatically during the potential handover.

FIG. 5 illustrates an example of a driving scenario where the leading vehicle disengages with the following vehicle from a group due to a potential handover.

### DETAILED DESCRIPTION

Systems, methods, and other embodiments associated with disengaging a grouped vehicle by transferring control to an operator safely from a communication interruption are disclosed herein. In various implementations, a system executing cooperative control leads to unsafe driving conditions for operators from sudden or unexpected handovers (i.e., limited automated control). For example, a traffic scenario includes a following vehicle traveling closely behind a leading vehicle automatically in a group on a congested highway and the group experiences a communication interruption that suddenly triggers a handover without warning. As such, the traffic scenario may create an unsafe condition as the system of the following vehicle gives the operator vehicle control when closely behind the leading vehicle, which is a feature for grouped vehicles. The system also deprives the operator an opportunity for adjusting to a driving environment with attention being elsewhere during automated driving associated with cooperative control. Thus, systems for cooperative control that hand-over vehicle control to an operator abruptly and unexpectedly can place operators in traffic scenarios that are dangerous.

Therefore, in one embodiment, a prediction system estimates a communication interruption for a wireless connection between following and leading vehicles traveling as a group to warn (e.g., audible feedback, visual feedback, haptic feedback, etc.) and prepare an operator about a potential handover. In this way, the prediction system allows a graceful handover to the operator when disengagement (i.e., leaving) of the following vehicle from the group is imminent, thereby improving safety and readiness. In one approach, the following vehicle continues to travel automatically after a warning but before a communication loss with the leading vehicle in the event that communication parameters (e.g., a signal strength, packet losses, quality of service (QoS), etc.) for the connection again become satisfactory over time.

Moreover, the prediction system may also increase a following-gap with the leading vehicle using sensor data (e.g., radar) after the warning but before the communication loss automatically without operator control. Once communication parameters signifying the communication loss are unsatisfied, the prediction system of the following vehicle automatically may follow an actual path history of the lead vehicle without operator control. In particular, the following vehicle selects a destination point on a previous path having motion parameters (e.g., velocity, acceleration, etc.) to follow until the actual path history is exhausted. Furthermore, the following vehicle may modify vehicle dynamics to match the motion parameters using controllers for navigation and steering that minimize motion error to the destination point. For example, the controllers are one of a linear-quadratic regulator (LQR), a proportional integral derivative (PID), and a model predictive control (MPC) for lateral and longitudinal control of the following vehicle that accurately navigates toward the destination point with automated control. In this way, the following vehicle operates automatically for an extended time period and takes pre-emptive actions during a communication interruption and losses associated with a potential handover, thereby improving operator awareness and safely transferring vehicle control to the operator.

In various implementations, the prediction system extrapolates a predicted path history of the leading vehicle to automatically maneuver the following vehicle with an estimated trajectory until the handover. Here, the predicted path history may have estimated motion parameters (e.g., velocity, acceleration, etc.) that degrade over time from data about the leading vehicle projected into the future becoming sparser. The prediction system selects a destination point from the predicted path history for the following vehicle and steers toward the destination point using a controller that minimizes motion error with automated control. As such, the operator is further given additional time for adapting and reorienting to traffic scenarios while the following vehicle automatically drives along the predicted path history. Accordingly, the prediction system executes actions that gracefully disengage and hand over a following vehicle to an operator during a communication interruption, thereby giving the operator time to regain an understanding of the surroundings before resuming vehicle control.

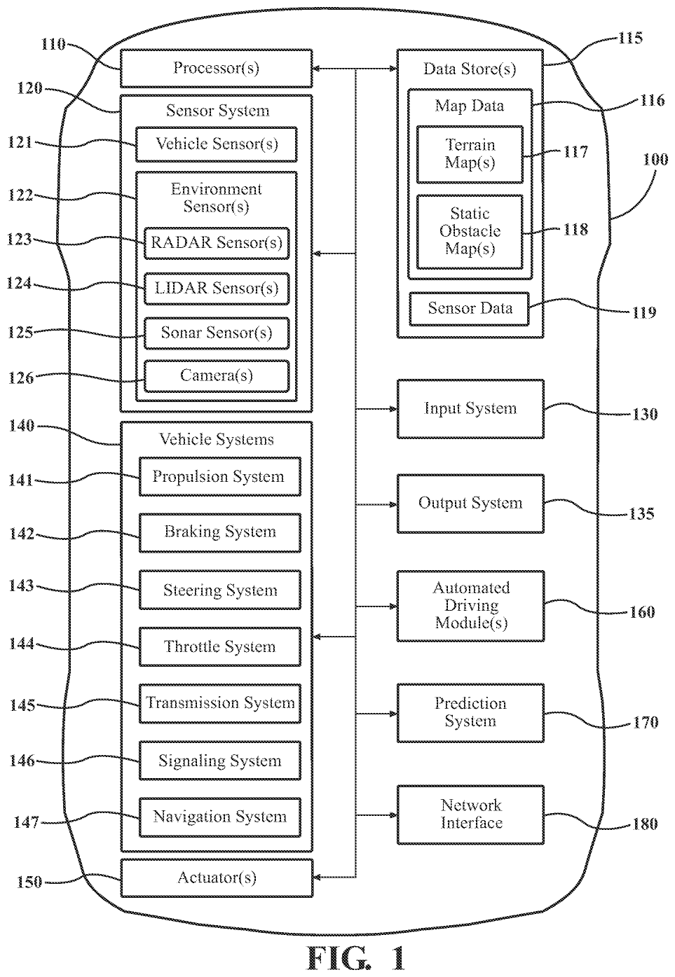

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the prediction system 170 uses road-side units (RSU), consumer electronics (CE), mobile devices, robots, drones, and so on that benefit from the functionality discussed herein associated with disengaging a grouped vehicle by transferring control to an operator safely from a communication interruption.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

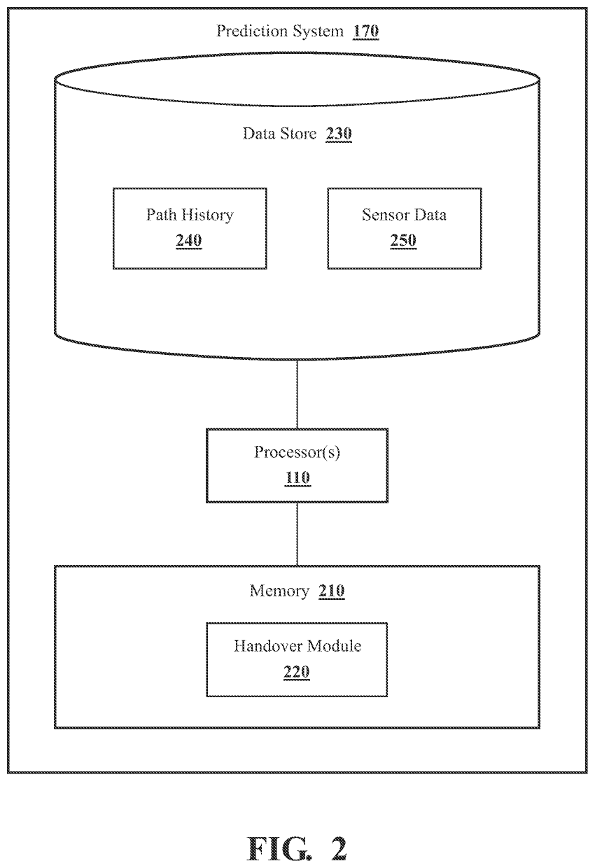

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a prediction system 170 that is implemented to perform methods and other functions as disclosed herein relating to improving disengaging a grouped vehicle by transferring control to an operator safely from a communication interruption.

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores a handover module 220. The memory 210 is a random-access memory (RAM), a read-only memory (ROM), a hard-disk drive, a flash memory, or other suitable memory for storing the handover module 220. The handover module 220 is, for example, computer-readable instructions that when executed by the processor(s) 110 cause the processor(s) 110 to perform the various functions disclosed herein.

The prediction system 170 as illustrated in FIG. 2 is generally an abstracted form of the prediction system 170. With reference to FIG. 2, the handover module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the handover module 220, in one embodiment, acquires the sensor data 250 that includes at least camera images. In further arrangements, the handover module 220 acquires the sensor data 250 from further sensors such as radar sensors 123, LIDAR sensors 124, and other sensors as may be suitable for identifying vehicles and locations of the vehicles.

Accordingly, the handover module 220, in one embodiment, controls the respective sensors to provide the data inputs in the form of the sensor data 250. Additionally, while the handover module 220 is discussed as controlling the various sensors to provide the sensor data 250, in one or more embodiments, the prediction system 170 and the handover module 220 can employ other techniques to acquire the sensor data 250 that are either active or passive. For example, the prediction system 170 may passively sniff the sensor data 250 from a stream of electronic information provided by the various sensors to further components within the vehicle 100. Moreover, the prediction system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 may also include, for example, information about lane markings, and so on. In alternative embodiments, the sensor data 250 includes information about a forward direction alone when, for example, the vehicle 100 is not equipped with further sensors to include additional regions about the vehicle and/or the additional regions are not scanned due to other reasons.

Moreover, in one embodiment, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the handover module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes the path history 240 that may include a velocity, an acceleration, heading, and so on of the leading vehicle associated with particular points and a geographic location. In one approach, the following vehicle continuously or periodically records the path history by processing the sensor data 250 with a computer vision model. For instance, the prediction system 170 estimates an actual path history using features about a leading vehicle extracted from images of the sensor data 250. The following vehicle can also receive the path history of the leading vehicle using a protocol (e.g., vehicle-to-everything (V2X), dedicated short-range communications (DSRC), vehicle-to-vehicle (V2V), a local area network (LAN), a wide area network (WAN), etc.) over the network interface 180.

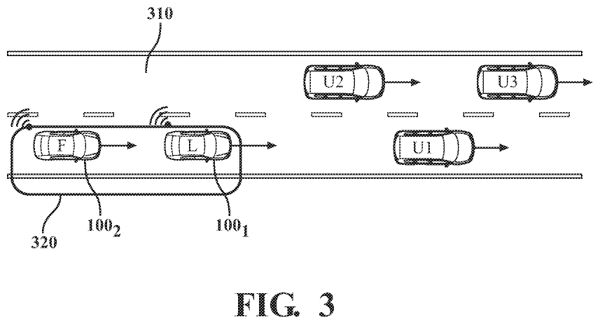

Turning now to FIG. 3, one example of the prediction system 170 controlling a following vehicle traveling in a group 320 with a leading vehicle where a communication interruption causes a potential disengagement and handover is illustrated. The group 320 may include the leading vehicle 100₁ and the following vehicle 100₂ and any quantity of other vehicles traveling together using cooperative control. In one approach, the leading vehicle 100₁ is referenced as a preceding vehicle that is the first vehicle in the group 320, located in the middle, and so on. In other words, a leading vehicle is a relative term referring to a vehicle preceding a following vehicle or any other vehicle within grouped vehicles that are controlled for traveling cooperatively.

In FIG. 3, the prediction system 170 includes instructions that cause the processor 110 to estimate a communication interruption between the leading vehicle 100₁ and the following vehicle 100₂ automatically traveling on the road 310 as a group 320 (e.g., a platoon) using the automated driving module(s) 160. The communication interruption may be a temporary, short-term, and so on disturbance that causes a connection to approach threshold levels for certain communication parameters. Here, the communication parameters can be one of a signal strength, packet losses, signal-to-noise ratio (SNR), signal-noise and interference-ratio (SNIR), QoS, and so on about a current connection between the leading vehicle 100₁ and the following vehicle 100₂. The communication parameters can represent real-time or recent performance measurements for the connection between the vehicles. In response, the prediction system 170 may generate feedback that warns an operator of the following vehicle 100₂ about a potential disengagement with the group 320 during the communication interruption but before a communication loss while still traveling automatically within the group 320. Here, the warning can be audible feedback, visual feedback, haptic feedback, and so on from the human-to-machine interface (HMI) of the following vehicle 100₂. In this way, the warning allows the operator to prepare for a potential disengagement and a handover of driving control associated with the group 320.

Moreover, the communication loss may be designated when the communication parameters become unsatisfactory for safely coordinating travel within the group 320. For instance, interference from unconnected vehicles U1-U3 traveling on the road 310 causes the SNR to drop below a threshold (e.g., 1 decibel (dB)) and a connection failure. Here, the prediction system 170 may wait for a possible recovery from the communication failure and re-establishment of the connection with the leading vehicle 100₁ by retaining the following vehicle 100₂ within the group 320. Even before the communication loss, in one approach, the prediction system 170 and the following vehicle 100₂ automatically disengage a tailgating orientation and increase a following-gap (e.g., a time headway of one second) using the automated driving module(s) 160.

In various implementations, repositioning vehicles within the group 320 avoids the operator of the following vehicle 100₂ from potentially taking over control at an unsafe following-gap that is a separation distance associated with grouped vehicles. In particular, the following-gap of the group 320 decreases drag and prevents cut-ins by the unconnected vehicles U1-U3 but is otherwise unsafe for manual driving. The increased following-gap also assists forward-facing cameras, radar sensors 123, LIDAR sensors 124, and so on of the following vehicle 100₂ with acquiring data about lane lines for assisted control (e.g., lane-keeping) by the automated driving module(s) 160 unassociated with the group 320 during the communication interruption. Furthermore, the repositioning gives the operator an opportunity to reorient and understand a traffic scenario (e.g., lane merge, toll plaza, etc.) surrounding the following vehicle 100₂ before operator intervention. In the event that the communication interruption is temporary, the prediction system 170 may also return the following vehicle 100₂ in close proximity with the leading vehicle 100₁ by decreasing the following-gap. Accordingly, the prediction system 170 estimates potential communication losses and automatically initiates preemptive actions for the following vehicle 100₂, thereby avoiding unsafe disengagement and a hand-over from the group 320.

After the communication loss where the communication parameters are unsatisfied (e.g., excessive noise), the prediction system 170 controls the following vehicle 100₂ automatically using an actual path history for the leading vehicle 100₁ from the path history 240 and the automated driving module(s) 160 until exhaustion, depletion, and so on of the actual path history. In various implementations, the prediction system 170 of the following vehicle 100₂ adapts the actual path history for the current traffic scenario and selects a destination point on a previous path from the actual path history. Here, the destination point has motion parameters that include a velocity and an acceleration of the leading vehicle 100₁ associated with a geographic location. Furthermore, the prediction system 170 can modify vehicle dynamics of the following vehicle 100₂ to match the motion parameters associated with the destination point using controllers for navigation and steering that minimizes motion error to the destination point with the automated driving module(s) 160. For example, the controllers are one of a LQR, a PID, and a MPC for lateral and longitudinal control of the following vehicle 100₂. In one approach, similar to the operation prior to the communication loss, the prediction system 170 and the following vehicle 100₂ also automatically disengage a tailgating orientation and increase a following-gap spacing for safety.

Once the actual path history is exhausted, the prediction system 170 can initiate a graceful handover of vehicle control by maneuvering the following vehicle 100₂ with an estimated trajectory automatically using a predicted path history for the leading vehicle 100₁ and the automated driving module(s) 160. In this way, the operator is given additional time (e.g., multiple seconds) to understand the traffic scenario prior to a handover and resuming driving control. Here, the prediction system 170 extrapolates and models the predicted path history as a dashed, curved, and so on path of points. The predicted path history may be associated with estimated motion parameters and a confidence that reduces over time from dropping data reliability. For example, the estimated motion parameters include one of a velocity, an acceleration, a yaw rate, position, and so on about the leading vehicle 100₁. In one approach, the prediction system 170 of the following vehicle 100₂ derives the estimated motion parameters from the last recorded speed, acceleration, yaw rate, position, and so on associated with the leading vehicle 100₁.

In various implementations, the prediction system 170 uses a machine learning algorithm (e.g., a convolutional neural network (CNN), deep convolutional encoder-decoder architectures, etc.), that performs semantic segmentation over the sensor data 250 for estimating the predicted path history and the motion parameters. For example, the prediction system 170 in the following vehicle 100₂ generates semantic labels for separate object classes represented in an image of a scene having the leading vehicle 100₁ and other objects. Therefore, the prediction system 170 can process the semantic labels in a depth model for estimating the predicted path history and the motion parameters accurately.

Moreover, the prediction system 170 of the following vehicle 100₂ selects a destination point from the predicted path history. The prediction system 170 can modify the vehicle dynamics of the following vehicle 100₂ to match the estimated motion parameters associated with the destination point using controllers for navigation and steering that minimize motion error toward the destination point with the automated driving module(s) 160. Here, the controllers may be one of a LQR, a PID, and a MPC for lateral and longitudinal controllers of the following vehicle 100₂. Therefore, the prediction system 170 controls the following vehicle 100₂ to follow actual and predicted path histories after a communication loss that gives the operator ample time for adjusting to a traffic scenario associated with handing over driving control from a vehicle group.

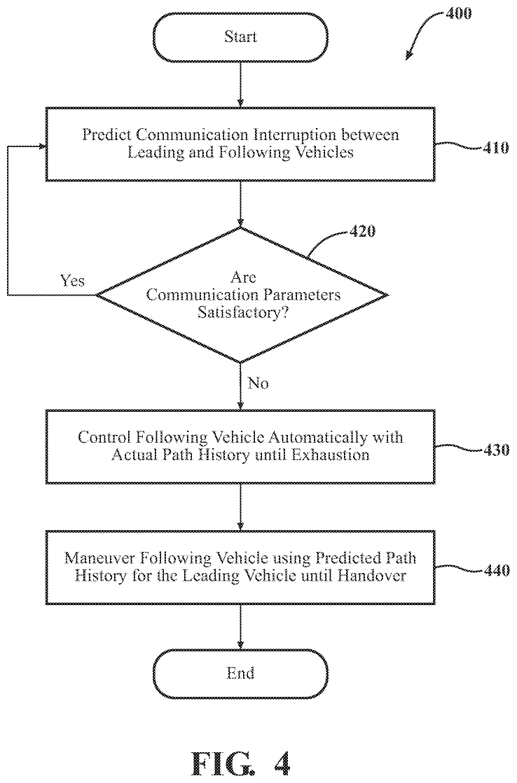

Now turning to FIG. 4, a flowchart of a method 400 that is associated with disengaging a grouped vehicle by transferring control to an operator safely from a communication interruption is illustrated. Method 400 will be discussed from the perspective of the prediction system 170 of FIGS. 1 and 2. While method 400 is discussed in combination with the prediction system 170, it should be appreciated that the method 400 is not limited to being implemented within the prediction system 170 but is instead one example of a system that may implement the method 400.

At 410, the prediction system 170 predicts a communication interruption between leading and following vehicles traveling in a group using the automated driving module(s) 160 for automated control. As previously explained, the communication interruption may be a temporary or a short-term disturbance that causes a connection between the leading and following vehicles to approach threshold levels for certain communication parameters. As a precaution, the prediction system 170 may generate feedback that warns an operator of the following vehicle about a potential disengagement with the group during the communication interruption. The warning may be generated before a communication loss while still traveling automatically. Here, the warning can be audible feedback, visual feedback, haptic feedback, and so on from the HMI generated by the following vehicle. Thus, the warning allows the operator to prepare for a potential disengagement and a handover of driving control from a vehicle group.

At 420, the prediction system 170 may designate a communication loss when the communication parameters become unsatisfactory for safely coordinating travel amongst grouped vehicles. For example, signal noise and interference from transmissions of surrounding vehicles causes the SNR to drop below a threshold and a connection failure. In one approach, the prediction system 170 waits for a possible recovery from the communication loss and re-establishment of the connection with the leading vehicle by retaining the following vehicle within the grouped vehicles. Otherwise, the handover module 220 prepares the following vehicle 100₂ for safely handing over to the operator driving control and disengaging from the grouped vehicles.

At 430, the prediction system 170 and the handover module 220 control the following vehicle automatically with an actual path history for the leading vehicle with the automated driving module(s) 160 until exhaustion when the communication parameters are unsatisfied. As previously explained, the prediction system 170 of the following vehicle adapts the actual path history for the current traffic scenario and selects a destination point on a previous path from the actual path history. Here, the destination point may have motion parameters that include a velocity, an acceleration, heading, and so on of the leading vehicle for a geographic location. Furthermore, the prediction system 170 can modify the vehicle dynamics of the following vehicle to match the motion parameters associated with the destination point using controllers for driving and steering that minimize motion error to the destination point. In one approach, the prediction system 170 and the following vehicle also automatically disengage a tailgating orientation and increase a following-gap spacing using the automated driving module(s) 160. The repositioning avoids the operator of the following vehicle from potentially taking over control at an unsafe following-gap that is a separation distance associated with grouped vehicles. As such, the repositioning gives the operator an opportunity to reorient and understand a traffic scenario (e.g., lane merge, toll plaza, etc.) surrounding the following vehicle before operator intervention.

At 440, the prediction system 170 maneuvers the following vehicle automatically using a predicted path history for the leading vehicle and the automated driving module(s) 160 until a handover. As such, the operator is given additional time (e.g., multiple seconds) to understand the traffic scenario prior to the handover and resuming driving control. In various implementations, after exhausting the actual path history, the prediction system 170 extrapolates and models the predicted path history as a path of points having estimated motion parameters. For example, the estimated motion parameters include one of a velocity, an acceleration, a yaw rate, a position, and so on about the leading vehicle. In one approach, the estimated motion parameters are computed and derived from the last recorded speed, acceleration, yaw rate, position, and so on associated with the leading vehicle.

Moreover, the prediction system 170 of the following vehicle selects a destination point from the predicted path history. The prediction system 170 can modify the vehicle dynamics of the following vehicle to match the estimated motion parameters associated with the destination point using controllers for driving and steering that minimize motion error to the destination point. Accordingly, the prediction system executes actions that gracefully disengage and hand-over a following vehicle in a vehicle grouping to an operator for mitigating a communication interruption using path histories that afford the operator ample opportunities for familiarizing with a traffic scenario.

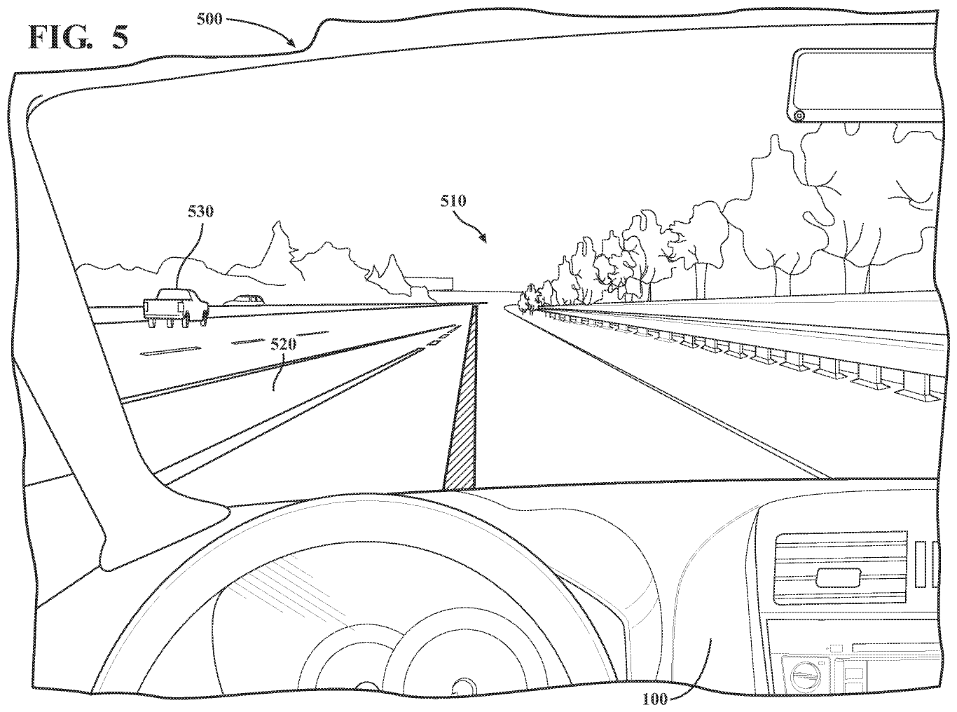

Turning now to FIG. 5, an example 500 of a driving scenario 510 where the leading vehicle 100 disengages with a following vehicle from a group due to a potential handover is illustrated. Here, the leading vehicle 100 is traveling on the road 520 including the vehicle 530. A communication interruption to the group is caused by transmissions of the vehicle 530. As such, the following vehicle warns the operator using an HMI and may take precautionary measures by increasing the following-gap with the leading vehicle 100. In the event that the communication interruption is temporary, the prediction system 170 may also return the following vehicle proximity close with the leading vehicle 100 by decreasing the following-gap.

Moreover, the prediction system 170 controls the following vehicle automatically with an actual path history and the automated driving module(s) 160 until exhaustion when the communication interruption unsatisfies communication parameters. Here, the communication parameters can be one of a signal strength, packet losses, SNR, SNIR, QoS, and so on that represent real-time or recent performance about a current connection between the leading vehicle and the following vehicle. Furthermore, as previously explained, the prediction system 170 maneuvers the following vehicle automatically using a predicted path history for the leading vehicle and the automated driving module(s) 160 until a handover. In one approach, as previously explained, the prediction system 170 modifies the vehicle dynamics of the following vehicle to match estimated motion parameters associated with a destination point of the predicted path history using controllers for driving and steering that minimize motion error. Therefore, the prediction system 170 mitigates the effects of a communication interruption for a grouped vehicle that leads to an unsafe disengagement and a handover through automated actions, thereby giving the operator adequate opportunities for readjustment and reorientation.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system, comprising:
a memory storing instructions that, when executed by a processor, cause the processor to:
predict a communication interruption between a leading vehicle and a following vehicle that are traveling on a road as a group;
upon communication parameters being unsatisfied, control the following vehicle automatically using an actual path history for the leading vehicle until exhaustion; and
maneuver the following vehicle with an estimated trajectory using a predicted path history for the leading vehicle generated from a model following the exhaustion until a handover.

2. The prediction system of claim 1, wherein the instructions to control the following vehicle automatically further include instructions to:
adapt the actual path history of the leading vehicle by the following vehicle, the actual path history being continuously recorded by the following vehicle;
select a destination point on a previous path from the actual path history by the following vehicle, the destination point having motion parameters that include a velocity and an acceleration of the leading vehicle; and
modify vehicle dynamics of the following vehicle to match the motion parameters associated with the destination point, and the vehicle dynamics implement a controller for driving that minimizes motion error to the destination point.

3. The prediction system of claim 1, wherein the instructions to maneuver the following vehicle further include instructions to:
extrapolate the predicted path history of the leading vehicle, the predicted path history having estimated motion parameters and a confidence that reduces over time;
select a destination point from the predicted path history by the following vehicle; and
modify vehicle dynamics of the following vehicle to match the estimated motion parameters associated with the destination point, and the vehicle dynamics implement a controller for driving that minimizes motion error to the destination point.

4. The prediction system of claim 3, wherein the estimated motion parameters are one of a velocity, an acceleration, a yaw rate, and a position about the leading vehicle.

5. The prediction system of claim 1 further including instructions to:
upon the communication parameters being unsatisfied, disengage a tailgating orientation between the following vehicle and the leading vehicle by increasing a following-gap.

6. The prediction system of claim 1, wherein the instructions to predict the communication interruption further include instructions to:
generate feedback that warns an operator of the following vehicle about disengagement with the group before a communication loss, the following vehicle traveling automatically within the group after the feedback; and
disengage a tailgating orientation between the following vehicle and the leading vehicle by increasing a following-gap that is a separation distance.

7. The prediction system of claim 1, wherein the group includes other vehicles and the leading vehicle is near a center of the group.

8. The prediction system of claim 1, wherein the communication parameters being unsatisfied indicates a communication loss between the leading vehicle and the following vehicle for traveling on the road as the group.

9. The prediction system of claim 1, wherein the communication parameters are one of a signal strength, packet losses, signal-to-noise ratio (SNR), signal-noise and interference-ratio (SNIR), and a quality of service (QoS) for a current connection between the following vehicle and the leading vehicle.

10. A non-transitory computer-readable medium comprising:
instructions that when executed by a processor cause the processor to:
predict a communication interruption between a leading vehicle and a following vehicle that are traveling on a road as a group;
upon communication parameters being unsatisfied, control the following vehicle automatically using an actual path history for the leading vehicle until exhaustion; and
maneuver the following vehicle with an estimated trajectory using a predicted path history for the leading vehicle generated from a model following the exhaustion until a handover.

11. The non-transitory computer-readable medium of claim 10, wherein the instructions to control the following vehicle automatically further include instructions to:
adapt the actual path history of the leading vehicle by the following vehicle, the actual path history being continuously recorded by the following vehicle;
select a destination point on a previous path from the actual path history by the following vehicle, the destination point having motion parameters that include a velocity and an acceleration of the leading vehicle; and
modify vehicle dynamics of the following vehicle to match the motion parameters associated with the destination point, and the vehicle dynamics implement a controller for driving that minimizes motion error to the destination point.

12. A method, comprising:
predicting a communication interruption between a leading vehicle and a following vehicle that are traveling on a road as a group;
upon communication parameters being unsatisfied, controlling the following vehicle automatically using an actual path history for the leading vehicle until exhaustion; and
maneuvering the following vehicle with an estimated trajectory using a predicted path history for the leading vehicle generated from a model following the exhaustion until a handover.

13. The method of claim 12, wherein controlling the following vehicle automatically further includes:
adapting the actual path history of the leading vehicle by the following vehicle, the actual path history being continuously recorded by the following vehicle;
selecting a destination point on a previous path from the actual path history by the following vehicle, the destination point having motion parameters that include a velocity and an acceleration of the leading vehicle; and
modifying vehicle dynamics of the following vehicle to match the motion parameters associated with the destination point, the vehicle dynamics implement a controller for driving that minimizes motion error to the destination point.

14. The method of claim 12, wherein maneuvering the following vehicle further includes:
extrapolating the predicted path history of the leading vehicle, the predicted path history having estimated motion parameters and a confidence that reduces over time;
selecting a destination point from the predicted path history by the following vehicle; and
modifying vehicle dynamics of the following vehicle to match the estimated motion parameters associated with the destination point, and the vehicle dynamics implement a controller for driving that minimizes motion error to the destination point.

15. The method of claim 14, wherein the estimated motion parameters are one of a velocity, an acceleration, a yaw rate, and a position about the leading vehicle.

16. The method of claim 12 further comprising:
upon the communication parameters being unsatisfied, disengaging a tailgating orientation between the following vehicle and the leading vehicle by increasing a following-gap.

17. The method of claim 12, wherein predicting the communication interruption further includes:
generating feedback that warns an operator of the following vehicle about disengagement with the group before a communication loss, the following vehicle traveling automatically within the group after the feedback; and
disengaging a tailgating orientation between the following vehicle and the leading vehicle by increasing a following-gap that is a separation distance.

18. The method of claim 12, wherein the group includes other vehicles and the leading vehicle is near a center of the group.

19. The method of claim 12, wherein the communication parameters being unsatisfied indicates a communication loss between the leading vehicle and the following vehicle for traveling on the road as the group.

20. The method of claim 12, wherein the communication parameters are one of a signal strength, packet losses, signal-to-noise ratio (SNR), signal-noise and interference-ratio (SNIR), and a quality of service (QoS) for a current connection between the following vehicle and the leading vehicle.
